(19) United States
(12) Patent Application Publication
(10) Pub. No.: US 2026/0050460 A1
(43) Pub. Date: Feb. 19, 2026

(54) VIRTUAL MEMORY OVERPROVISIONING USING A HARDWARE-BASED INPUT/OUTPUT MEMORY MANAGEMENT UNIT

(71) Applicants: ADVANCED MICRO DEVICES, INC., Santa Clara, CA (US); ATI TECHNOLOGIES ULC, Markham (CA)

(72) Inventors: Wei Sheng, Shanghai (CN); Neerav Jiten Parikh, Portland, OR (US); Santosh Kumar Ravindranath Shukla, Bangalore (IN); Nippon Raval, Markham (CA)

(21) Appl. No.: 18/802,645

(22) Filed: Aug. 13, 2024

(51) Int. Cl. G06F 9/455

(52) U.S. Cl. CPC G06F 9/45558; G06F 2009/45579

(57) ABSTRACT

To pin pages of a virtual memory space allocated to a virtual machine (VM) controlling an input/output (I/O) device of a system, an input/output memory management unit (IOMMU) driver of the VM first loads pinning commands into a queue that indicate whether each page in the virtual memory space is to be pinned or unpinned. A hardware-based IOMMU of the system then retrieves the pinning commands from the queue and based on the retrieved commands, provides data to a hypervisor of the system indicating which pin commands are to be performed. Using this data provided by the hardware-based IOMMU, the hypervisor pins and unpins the pages of the virtual memory space.

### BACKGROUND

Within some processing systems, multiple virtual machines (VMs) run on a host system and are configured to control respective input/output (I/O) devices such that the virtual machines are enabled to use the I/O devices to execute operations and instructions for applications. To help enable these VMs to execute these operations and instructions using the I/O devices, a hypervisor supports a virtual memory space including virtual addresses that each represent corresponding portions of the physical system memory. The hypervisor is configured to allocate respective virtual addresses of this virtual memory space to each VM which allows the VMs to store data in the system memory that is used in or resulting from the execution operations and instructions executed by the I/O device. Additionally, to allow the I/O devices controlled by the VMs to access the data stored in the system memory, the I/O devices are configured to provide memory access requests that indicate virtual addresses to an input/output memory management unit (IOMMU). This IOMMU is then configured to determine which portions of the system memory correspond to the virtual addresses indicated in the memory access requests and fulfill the memory access requests at the determined portions of the system memory.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to perform virtual memory overprovisioning using a hardware-based input/output memory management unit (IOMMU), in accordance with some embodiments.

FIG. 2 is a flow diagram of an example operation for pinning pages to be used by a virtual machine (VM) using a hardware-based IOMMU, in accordance with some embodiments.

FIG. 3 is a block diagram of an example system architecture for pinning pages to be used by a VM controlling a virtual function of an input/output (I/O) device, in accordance with some embodiments.

FIG. 4 is a flow diagram of an example method for virtual memory overprovisioning using a hardware-based IOMMU, in accordance with some embodiments.

### DETAILED DESCRIPTION

Systems and techniques disclosed herein include a processing system having one or more guest virtual machines (hereinafter “VMs” for brevity) executed by a host processing unit such as a central processing unit (CPU), acceleration unit (AU), or the like. These VMs are each configured to control (e.g., execute operations or instructions on) one or more input/output (I/O) devices using, for example, PCI passthrough, single-root input/output virtualization (SR-IOV), or both. Such I/O devices controlled by the VMs include one or more peripheral component interconnect (PCI) devices, peripheral component interconnect express (PIC-e) devices, or both such as one or more AUs, network cards, sound cards, hard disk drive host adapters, redundant array of inexpensive disks (RAID) controllers, universal serial bus (USB) host controllers, modems, non-volatile memory express (NVMe) controllers, or any combination thereof, to name a few. To allow the VMs to control these I/O devices, the host processing unit executes a hypervisor configured to allocate one or more respective portions of an I/O device to a VM such that the VM is enabled to have exclusive control of the allocated portions of the I/O device. For example, the hypervisor is configured to allocate the network interface controller (NIC) of an I/O device to a VM such that the VM has exclusive access to the NIC and is enabled to control the I/O device. As another example, a hypervisor is configured to allocate one or more virtual functions (VFs) supported by an I/O device to a VM such that the VM has exclusive access to the VFs of the I/O device. Such virtual functions, for example, each represent respective portions of an I/O device configured to perform the main function (e.g., physical function) of the I/O device.

Further, each VM is associated with a virtual memory space that indicates sets of guest virtual memory addresses (e.g., also referred to herein as “pages”) available to applications executed by the VM. That is, each VM is associated with a virtual memory space that indicates pages accessible by the VM. These pages of the virtual memory space include, for example, guest physical addresses (GPAs) that indicate addresses within the VM that each correspond to respective system physical addresses (SPAs) in the physical memory of the system (also referred to herein as “system memory”). In response to a VM launching, the hypervisor determines the virtual memory space of the VM based on one or more predetermined values indicated by the VM (e.g., predetermined values indicating an amount of virtual memory to be made available to the VM), the performance of the VM, the historical performance of the VM, or any combination thereof. After determining the virtual memory space associated with a VM, the hypervisor then pins the pages (e.g., sets of GPAs) of the virtual memory space to corresponding system physical addresses of the system memory such that other VMs (e.g., I/O devices controlled by other VMs) are prevented from modifying the data stored in the pages. For example, based on a page being pinned to corresponding SPAs, the hypervisor is unable to reallocate that page to another VM, preventing I/O devices controlled by other VMs from modifying the data stored in the page. To pin a page, for example, the hypervisor is configured to update one or more flags stored within the page indicating whether the page is pinned or unpinned and update a set of host page tables mapping the GPAs of the page to corresponding SPAs.

Based on certain applications executed by a VM, the I/O device allocated to the VM is configured to read, write, or fetch data to or from memory addresses in the system memory corresponding to the virtual memory space of the VM. To allow the I/O device access to the system memory, the system includes a hardware-based input/output memory management unit (also referred to herein as a “hardware IOMMU” for brevity) configured to handle memory access requests from an I/O device. For example, in response to receiving a memory access request from an I/O device allocated to a VM that indicates one or more virtual addresses such as guest input/output virtual addresses (gIOVAs) or guest virtual addresses (GVAs), the hardware IOMMU translates the indicated virtual addresses to corresponding GPAs, SPAs, or both based on one or more page tables. As an example, each VM includes a respective IOMMU driver configured to maintain a set of guest page tables that map the virtual addresses associated with the VM (e.g., gIOVAs, GVAs) to corresponding GPAs of the VM. Further, the hypervisor is configured to maintain one or more sets of host page tables that map the GPAs of the VMs to corresponding SPAs in the system memory. Using these sets of page tables maintained by the IOMMU driver and hypervisor, respectively, the hardware IOMMU is configured to translate the virtual memory addresses indicated in a memory access request from an I/O device controlled by a VM to respective SPAs in the system memory. After translating the virtual memory addresses indicated in the memory access request, the hardware IOMMU fulfills the memory access request at the translated SPA in the system memory.

In this way, an I/O device controlled by a VM is configured to access the system memory based on the virtual memory space assigned to the VM. Further, because the hypervisor virtual pins the pages of a virtual memory space assigned to a VM, the hypervisor helps to prevent errors in the execution of the VM due to data in the virtual memory space being modified by I/O devices controlled by other VMs. However, when applications executed by the VM do not use the entire virtual memory space allocated to the VM, pinning all the pages within the virtual memory space prevents those pages from being reallocated to other VMs. Due to this, these pages go unused while the VM is executing, limiting the efficiency of memory management for the processing system and also limiting the number of VMs that may be concurrently executed on the system. As such, systems and techniques disclosed herein are directed to virtual memory overprovisioning using a hardware IOMMU. For example, based on a VM being launched by the system, the hypervisor first allocates a virtual memory space to the VM based on one or more predetermined values indicated by the VM (e.g., predetermined values indicating an amount of memory to be made available to the VM), the performance of the VM, the historical performance of the VM, or any combination thereof. After the virtual memory space has been allocated to the VM, the IOMMU driver of the VM determines which pages within the allocated virtual memory space will be used by applications executed by the VM. For example, based on the program code of the applications to be executed by the VM, the IOMMU driver of the VM determines which pages within the virtual memory space are to be used. The IOMMU driver then loads (e.g., enqueues) pinning commands into a queue connected at a first end (e.g., tail) to the IOMMU driver (e.g., the processing unit running the IOMMU driver) and at a second end (head) to the hardware IOMMU. These pinning commands, for example, each include data indicating whether a corresponding page of the virtual memory space allocated to the VM is to be pinned or unpinned. As an example, a pinning command includes data indicating whether a set of virtual addresses (e.g., gIOVAs, GVAs, GPAs) associated with a page is to be pinned such that the page is not able to be reallocated to another VM or unpinned such that the page is able to be reallocated to another VM.

After one or more pinning commands have been loaded into the queue by the IOMMU driver, the hardware IOMMU retrieves (e.g., dequeues) the pinning commands from the queue and sanitizes the pin commands for the hypervisor. Sanitizing the pin commands for the hypervisor includes, for example, providing data to the hypervisor indicating which pages within the virtual memory space are to be pinned, unpinned, or both. For example, for each retrieved pinning command indicating a page is to be unpinned, the hardware IOMMU first translates the GVAs of the page into GPAs using one or more page tables maintained by the IOMMU driver of the VM. The hardware IOMMU then provides data to the hypervisor indicating the GPAs of the page and that the page is to be unpinned. Likewise, for each retrieved pinning command indicating a page of GVAs is to be pinned, the hardware IOMMU first translates the GVAs of the page into GPAs using one or more page tables maintained by the IOMMU driver of the VM. The hardware IOMMU then provides data to the hypervisor indicating the GPAs of the page and that the page is to be pinned. Based on the data provided from the hardware IOMMU, the hypervisor then pins or unpins the pages of the virtual memory space. For example, based on the data from the hardware IOMMU indicating a page is to be pinned, the hypervisor updates a set of page tables to map the GPAs of the page to corresponding SPAs and then updates a flag in the page to indicate that the page is pinned. As another example, based on the data from the hardware IOMMU indicating a page is to be unpinned, the hypervisor updates a set of page tables to unmap the GPAs of the page from respective SPAs and then unpins the page by updating a flag in the page to indicate that the page is unpinned.

Further, after pinning, unpinning, or both the pages of the virtual memory space as indicated by the data provided from the hardware IOMMU, the hypervisor notifies the hardware IOMMU that pinning of the virtual memory space has been completed. The hardware IOMMU also, in turn, notifies the IOMMU driver of the VM that the pinning of the virtual memory space has been completed. The IOMMU driver then updates one or more sets of guest page tables to map the GPAs of the pinned pages of the virtual memory space to respective GVAs, gIOVAs, or both. In this way, the system is configured to pin only the virtual addresses within a virtual memory space that are indicated to be used by a corresponding VM controlling an I/O device, reducing the number of pages within the virtual memory space allocated to the VM controlling an I/O device that go unused. Further, by reducing the number of pages that go unused, the amount of virtual memory free to allocate to other VMs is increased, allowing the system to concurrently execute more VMs and increasing processing efficiency.

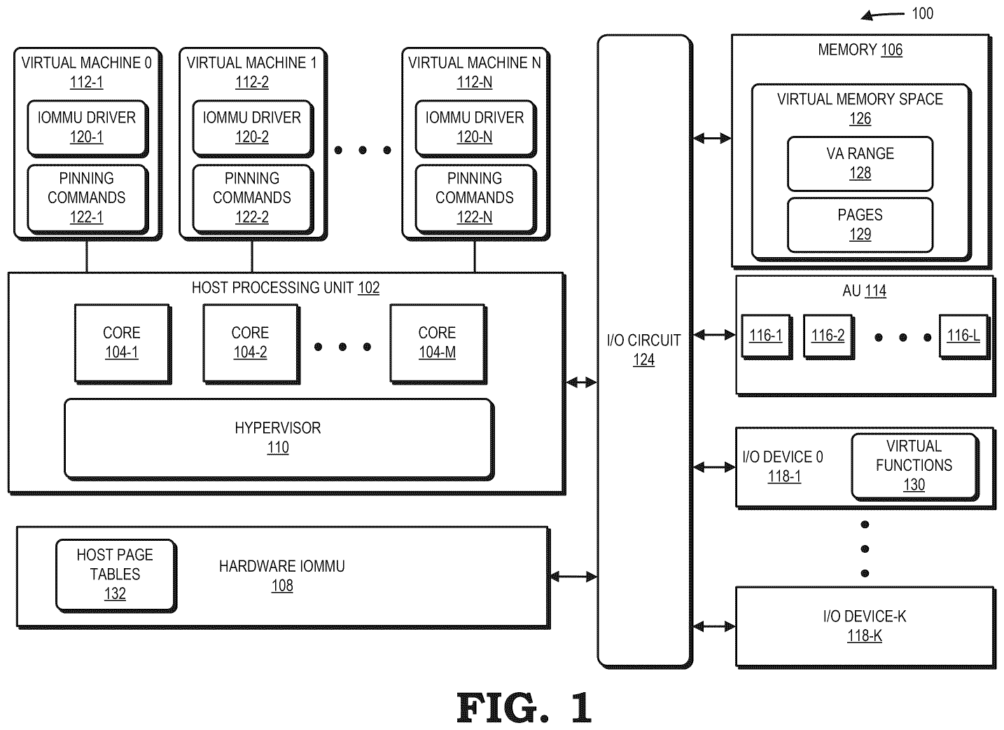

Referring now to FIG. 1, a processing system 100 configured to perform virtual memory overprovisioning using a hardware IOMMU is presented, in accordance with embodiments. For example, processing system 100 includes a host processing unit 102 configured to concurrently run one or more guest virtual machines (VMs) 112. According to some embodiments, for example, host processing unit 102 includes a central processing unit (CPU) implementing one or more processor cores 104 that execute instructions, operations, or both for one or more applications, VMs, 112, or both concurrently or in parallel. In other implementations, host processing unit 102 includes an acceleration unit (AU) that includes one or more processor cores 104 each operating as one or more compute units (e.g., sets of single instruction, multiple data (SIMD) units) that perform the same operation for different data sets. As an example, an AU includes one or more vector processors, coprocessors, graphics processing units (GPUs), general-purpose GPUs (GPGPUs), non-scalar processors, highly parallel processors, artificial intelligence (AI) processors, inference engines, machine-learning processors, other multithreaded processing units, scalar processors, serial processors, programmable logic devices (e.g., field-programmable logic devices (FPGAs)), or any combination thereof. Though the example embodiment presented in FIG. 1 shows host processing unit 102 as including three processor cores (104-1, 104-2, 104-M) representing an M integer number of processor cores (where M>0), in other embodiments, host processing unit 102 may include any integer number of processor cores 104. Further, though the example embodiment presented in FIG. 1 shows host processing unit 102 as concurrently running three VMs (112-1, 112-2, 112-N) representing an N integer number of VMs (where N>0), in other implementations, host processing is configured to concurrently run any integer number of VMs 112.

Each VM 112 running on host processing unit 102 is configured to directly control one or more I/O devices 118 using Direct I/O, PCI passthrough, SR-IOV, or any combination thereof. As an example, using PCI passthrough, a VM 112 is configured to control the NIC of an I/O device 118 such that the VM 112 controls the functionality of the I/O device 118. As another example, using SR-IOV, a VM 112 is configured to control one or more virtual functions 130 presented by an I/O device 118 (e.g., control one or more virtual NICs associated with the virtual functions 130) such that the VM 112 is enabled to use the virtual functions of the I/O device 118. Such virtual functions 130, for example, each represent at least a portion of an I/O device 118 (e.g., a group of resources of the I/O device 118) configured to perform a physical function of the I/O device 118 (e.g., the main function of the I/O device 118). These I/O devices 118 include, for example, one or more PCI devices, PCI-e devices, or both. For example, I/O devices 118 include one or more AUs, network cards, sound cards, hard disk drive host adapters, RAID controllers, modems, USB controllers, NVMe controllers, or any combination thereof, to name a few. As an example, an I/O device includes an AU 114 configured to operate as one or more vector processors, coprocessors, GPUs, GPGPUs, non-scalar processors, highly parallel processors, AI processors, inference engines, machine-learning processors, other multithreaded processing units, scalar processors, serial processors, programmable logic devices (e.g., FPGAs), or any combination thereof. Such an AU 114 includes one or more compute units 116 each having one or more sets of SIMD units that perform the same operation for different data sets. Though the example embodiment provided in FIG. 1 shows the AU 114 as including three compute units (116-1, 116-2, 116-L) representing an L integer number of compute units (where L>0), in other embodiments, AU 114 can include any integer number of compute units 116. Additionally, though the example embodiment in FIG. 1 presents processing system 100 as including two I/O devices (118-1, 118-K) representing a K integer number of I/O devices (where K>0), in other embodiments, processing system 100 can include any integer number of I/O devices 118.

To manage the VMs 112 concurrently running on host processing unit 102, host processing unit 102 is configured to execute hypervisor 110. For example, one or more processor cores 104 are configured to execute one or more instructions, operations, or both for hypervisor 110. For each VM 112 that is launched, hypervisor 110 is configured to allocate a respective virtual memory space 126 to the VM 112. Each virtual memory space 126 includes a range of virtual addresses (e.g., VA range 128) that corresponds to respective portions of memory 106. As an example, hypervisor 110 allocates a virtual memory space 126 that includes a VA range 128 having a number of virtual addresses (e.g., size) based on one or more predetermined values indicated by the VM 112 (e.g., predetermined values indicating an amount of memory to be made available to the VM 112), the performance of the VM 112, the historical performance of the VM 112, or any combination thereof. In implementations, a VA range 128 of a virtual memory space 126 includes a range of GPAs that correspond to SPAs within memory 106. Memory 106, for example, is implemented using a non-transitory computer-readable medium, for example, a dynamic random-access memory (DRAM). In some implementations, memory 106 is implemented using other types of memory including, for example, static random-access memory (SRAM), nonvolatile RAM, and the like. To allow an I/O device 118 controlled by a VM 112 to read, write, or fetch data from the portion of memory 106 corresponding to the virtual memory space 126 allocated to the VM 112, the I/O device 118 generates a memory access request that includes data representing a virtual address associated with the VA range 128 of the virtual memory space 126. As an example, the I/O device 118 generates a memory access request indicating a gIOVA corresponding to a GPA within the VA range 128 of the virtual memory space 126. After generating such a memory access request, the I/O device 118 provides the memory access request to a hardware IOMMU 108 configured to handle memory access requests from the I/O devices 118. Such a hardware IOMMU 108 includes hardware configured to handle memory access requests such as one or more programmable logic devices, fixed-function blocks, or the like implemented in an integrated circuit (IC), on a chiplet, or both.

Based on receiving a memory access request from an I/O device 118, hardware IOMMU 108 first translates the virtual addresses indicated by the memory access request to a virtual address within a VA range 128 of a respective virtual memory space 126 based on a set of page tables (e.g., guest page tables) maintained by a corresponding VM 112 (e.g., the VM controlling the I/O device 118 that sent the memory access request). For example, in implementations, each VM 112 includes a respective IOMMU driver (120-1, 120-2, 120-N) configured to maintain one or more sets of guest page tables that include data mapping virtual addresses associated with the operating system of the VM 112, the I/O device 118, or both (e.g., gIOVAs, GVAs) to the virtual addresses within a corresponding VA range 128 (e.g., GPAs). Using such guest page tables, hardware IOMMU 108 translates a virtual address indicated in a memory access request from an I/O device 118 to a virtual address within VA range 128. Hardware IOMMU 108 then translates the determined virtual address within VA range 128 to a physical address within memory 106. For example, in implementations, hypervisor 110 is configured to maintain one or more sets of host page tables 132 that include data mapping virtual addresses (e.g., GPAs) within a VA range 128 to corresponding physical addresses (e.g., SPAs) within memory 106. Using one or more host page tables 132, hardware IOMMU 108 translates the determined virtual address within VA range 128 to a physical address within memory 106 and fulfills the memory access request at the determined physical address within memory 106. To enable communication between the VMs 112 running on host processing unit 102, the I/O devices 118 controlled by the VMs 112, hardware IOMMU 108, and memory 106, processing system 100 includes I/O circuit 124. I/O circuit 124 includes, for example, one or more busses, switches (e.g., PCI switches), data fabrics, queues, buffers, or the like. As an example, in implementations, I/O circuit 124 is configured to connect the NIC of an I/O device 118 to one or more processor cores 104, hardware IOMMU 108, memory 106, or any combination thereof. As another example, I/O circuit 124 is configured to connect each VM 112 to hardware IOMMU 108.

To help prevent other VMs 112, I/O devices 118, or both from accessing the virtual memory space 126 allocated to a VM 112, hypervisor 110 is configured to pin the virtual addresses within the VA range 128 to physical addresses within memory 106 such that the virtual address cannot be reallocated to other VMs 112. That is, hypervisor 110 pins the pages 129 (e.g., sets of virtual addresses) formed from VA range 128 to corresponding physical addresses in memory 106 such that the pages 129 cannot be reallocated to other VMs 112. For example, by pinning a page 129, other VMs 112 cannot access the page 129 allocated to a first VM, preventing the other VMs 112 from modifying the data stored within the page 129 which could affect the operation of the first VM 112. To pin a page 129, for example, hypervisor 110 is configured to update one or more flags stored in the page 129 indicating whether the page is pinned or unpinned and then update one or more host page tables 132 to associate the GPAs of the page 129 with corresponding SPAs in memory 106. Further, to help increase the number of VMS 112 able to concurrently run on host processing unit 102, hypervisor 110 is configured to pin pages 129 based on the memory usage of a VM 112. That is, based on the actual or expected memory usage of the VM 112, the hypervisor 110 dynamically pins pages 129 within the virtual memory space 126 allocated to the VM 112 to allow for overprovisioning of virtual memory such that the number of VMs 112 able to concurrently run on host processing unit 102 is increased.

In embodiments, the IOMMU driver 120 of a VM 112 is configured to generate a respective pinning command 122 for each page 129 of the virtual memory space 126 allocated with the VM 112. Each of these pinning commands 122, for example, includes data indicating whether a corresponding page 129 of the virtual memory space 126 is to be pinned or unpinned. As an example, a pinning command 122 includes data indicating whether a range of addresses (e.g., gIOVAs, GVAs) corresponding to a page 129 is to be pinned or unpinned. To determine these pinning commands 122, the IOMMU driver 120 first determines which pages 129 of the virtual memory space 126 are to store data for one or more applications executed by the VM 112. For example, based on the program code of the applications to be executed by the VM 112, the IOMMU driver 120 determines which addresses of pages 129 within the VA range 128 of the virtual memory space 126 are going to store data for the applications. Based on determining that a page is going to store data for an application (e.g., be used), the IOMMU driver 120 generates a pinning command 122 indicating that the page 129 is to be pinned. Further, based on determining that a page 129 is not going to store data, the IOMMU driver 120 generates a pinning command 122 indicating that the page 129 is not to be pinned (e.g., is to be unpinned). After generating a pinning command 122 for a respective page 129, the IOMMU driver 120 loads (e.g., enqueues) the pinning command 122 into a queue accessible by the IOMMU driver 120 (e.g., the processor cores 104 executing the VM 112 of the IOMMU driver 120) and hardware IOMMU 108. In implementations, this queue accessible by the VM 112, IOMMU driver 120, hardware IOMMU 108, or any combination thereof is implemented as a queue (e.g., virtualized hardware queue) in I/O circuit 124, hardware IOMMU 108, or both.

Based on the pinning commands 122 generated by IOMMU driver 120, hardware IOMMU 108 is configured to sanitize the pinning commands to be performed by the hypervisor 110. That is, hardware IOMMU 108 determines which pages 129 are to be pinned or unpinned based on the pinning commands 122. For example, hardware IOMMU 108 first retrieves (e.g., dequeues) one or more pinning commands 122 from the queue accessible by hardware IOMMU 108 and a respective IOMMU driver 120 (e.g., the VM 112 including the IOMMU driver 120). Based on a pinning command 122 indicating a respective page 129 is to be pinned, hardware IOMMU 108 determines that the virtual addresses of the page 129 are to be pinned. Further, based on a pinning command 122 indicating a respective page 129 is not to be pinned, hardware IOMMU 108 determines that the virtual addresses of the page 129 are not to be pinned. In implementations, hardware IOMMU 108 is configured to translate the virtual addresses of the pages 129 when determining whether the virtual addresses of the pages 129 are to be pinned or unpinned based on corresponding pinning commands 122. For example, based on a pinning command 122 indicating a respective page 129 is to be pinned or unpinned, hardware IOMMU 108 translates the virtual addresses (e.g., gIOVAs, GVAs) of the page 129 to GPAs using one or more guest page tables.

After determining whether a page 129 is to be pinned or unpinned based on corresponding pinning commands 122, hardware IOMMU 108 is configured to notify hypervisor 110 which pages are to be pinned, unpinned, or both. For example, for each page 129 determined to be pinned, hardware IOMMU 108 provides data to hypervisor 110 indicating the GPAs of the page 129 and that the page 129 is to be pinned. Further, as another example, for each page 129 determined to be unpinned (e.g., determined not to be pinned), hardware IOMMU 108 provides data to hypervisor 110 indicating the GPAs of the page 129 and that the page 129 is not to be pinned. To provide such data to hypervisor 110, in implementations, hardware IOMMU 108 is configured to store the data in a buffer, such as a circular buffer, accessible by both the hardware IOMMU 108 and the hypervisor 110 (e.g, the processor cores 104 executing the hypervisor 110). According to implementations, this buffer is implemented within I/O circuit 124. Based on the data provided from hardware IOMMU 108 indicating the GPAs of the pages 129, whether one or more pages 129 are to be pinned, whether one or more pages 129 are to be unpinned, or any combination thereof, hypervisor 110 is configured to pin the virtual addresses of the pages 129 to corresponding physical addresses in memory 106. For example, based on data indicating the GPAs of a page 129 and that the page is to be pinned, hypervisor 110 pins the GPAs of the page 129 to corresponding SPAs in memory 106. To pin a page 129, hypervisor 110 updates one or more values stored within the page 129 to indicate the page 129 is pinned or leaves one or more values stored within the page 129 indicating the page 129 is pinned unchanged. Hypervisor 110 then updates one or more host page tables 132 to associate the GPAs of the pinned pages 129 with their corresponding SPAs in memory 106. Further, based on data indicating the GPAs of a page 129 and that the page is not to be pinned, hypervisor 110 unpins the GPAs of the page 129. To unpin a page 129, hypervisor 110 updates one or more values stored within the page 129 to indicate the page 129 is unpinned or leaves one or more values stored within the page 129 indicating the page 129 is unpinned unchanged. Hypervisor 110 then updates one or more host page tables 132 to disassociate the GPAs of the unpinned page 129 with SPAs in memory 106.

After pinning or unpinning each page 129 indicated by the pinning commands 122 (e.g., each page 129 within the virtual memory space 126 allocated to a corresponding VM 112), hypervisor 110 provides data to hardware IOMMU 108 via, for example, I/O circuit 124, indicating that pinning of the pages 129 has been completed. Based on this notification, hardware IOMMU 108 then, in turn, notifies the IOMMU driver 120 of the corresponding VM 112 that pinning of the pages 129 has been completed via I/O circuit 124. As an example, hardware IOMMU 108 generates one or more guest events that include values indicating that pinning of the pages 129 has been completed and provides these guest events to a guest log of the IOMMU driver 120 of the corresponding VM 112. In response to receiving data indicating that pinning of the pages 129 has been completed, the IOMMU driver 120 updates one or more guest page tables based on which pages 129 have been pinned. For example, for each pinning command 122 generated by the IOMMU driver 120 indicating a respective page 129 is to be pinned, the IOMMU driver 120 updates one or more guest page tables such that the virtual addresses (e.g., gIOVAs, GVAs) of the page 129 corresponding to respective GPAs. In this way, processing system 100 is configured to pin pages 129 that are to be used by a VM 112, allowing for processing system 100 to concurrently run a greater number of VMs in general (e.g., both VMs controlling and not controlling I/O devices 118). For example, when compared to pinning the entirety of the pages 129 in a virtual memory space 126 allocated to a VM 112, only pinning the pages 129 to be used by the VM 112 increases the number of unpinned pages 129 available to be allocated to other VMs. Due to the greater number of unpinned pages 129 available for reallocation, the processing system 100 supports a greater number of virtual memory spaces 126 that be allocated to additional VMs, increasing the number of VMs the processing system 100 is enabled to concurrently run.

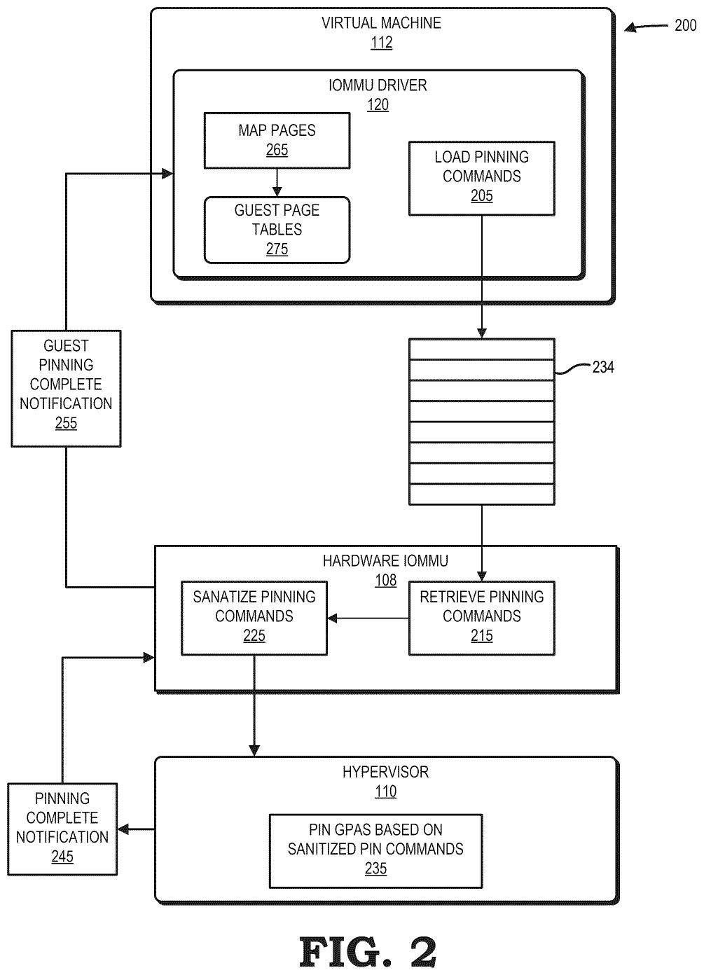

Referring now to FIG. 2, an example operation 200 for pinning pages to be used by a VM using a hardware IOMMU is presented, in accordance with embodiments. In embodiments, example operation 200 is implemented at least in part by host processing unit 102 and hardware IOMMU 108. Example operation 200 first includes VM 112 launching on processing system 100. Based on VM 112 launching on processing system 100, hypervisor 110 allocates a respective virtual memory space 126 to the VM 112 based on, for example, one or more predetermined values indicated by the VM 112, the performance of the VM 112, a historical performance of the VM 112, or any combination thereof. Based on the virtual memory space 126 allocated to the VM 112, at block 205, the IOMMU driver 120 of VM 112 loads (e.g., enqueues) one or more pinning commands 122 into a queue 234 accessible by the VM 112 (e.g., one or more processor cores 14 running the VM 112) and the hardware IOMMU 108. For example, for each page 129 of the virtual memory space 126 allocated to the VM 112, the IOMMU driver 120 determines whether the page 129 is to be used or unused by the VM 112 based on the program code of the applications to be executed by the VM 112. That is, the IOMMU driver 120 determines whether the applications executed by the VM 112 are to write, read, fetch, or any combination thereof data to or from, respectively, one or more virtual addresses in the page 129. Based on determining that a page 129 of the virtual memory space 126 is to be used (e.g., an application of the VM 112 is to write, read, fetch, or any combination thereof data to or from, respectively, virial addresses in the page 129), the IOMMU driver 120 stores a pinning command 122 in the queue 234 indicating that the page 129 is to be pinned. Further, based on determining that a page 129 of the virtual memory space 126 is not to be used (e.g., no application of the VM 112 will write, read, or fetch data to or from, respectively, virtual addresses of the page 129), the IOMMU driver 120 stores a pinning command 122 in the queue 234 indicating that the page 129 is to be unpinned. According to implementations, the pinning commands 122 stored in the queue 234 by IOMMU driver 120 indicate the virtual addresses (e.g., gIOVAs, GVAs) of the pages 129. Additionally, in implementations, queue 234 is included in or otherwise connected to the hardware IOMMU 108, I/O circuit 124, or both.

After the IOMMU driver 120 has loaded one or more pinning commands 122 into queue 234, at block 215, hardware IOMMU 108 is configured to retrieve (e.g., dequeue) the pinning commands 122 from the queue 234. Based on the pinning commands 122 retrieved from queue 234, at block 225, hardware IOMMU 108 is configured to sanitize the pinning commands to be performed by hypervisor 110. That is, hardware IOMMU 108 is configured to determine which pages 129 of the virtual memory space 126 are to be pinned by hypervisor 110, unpinned by hypervisor 110, or both. For example, still referring to block 225, for each retrieved pinning command 122 indicating a page 129 is to be pinned, hardware IOMMU 108 generates and provides data to hypervisor 110 indicating that the page 129 is to be pinned. As an example, hardware IOMMU 108 stores the data indicating the page 129 is to be pinned in a buffer (e.g., circular buffer) connected to the hardware IOMMU 108 and hypervisor 110 (e.g., one or more processor cores 104 executing the hypervisor 110). Additionally, for each retrieved pinning command 122 indicating a page 129 is not to be pinned (e.g., is to be unpinned), hardware IOMMU 108 generates and provides data to hypervisor 110 indicating that the page 129 is not to be pinned via, for example, a buffer. In some implementations, still referring to block 225, hardware IOMMU 108 is configured to translate the virtual addresses (e.g., gIOVAs, GVAs) of a page 129 to GPAs based on one or more guest page tables 275 before providing data to the hypervisor 110. As an example, based on a retrieved pinning command 122 indicating whether a page 129 is to be pinned or unpinned, hardware IOMMU 108 translates the virtual addresses (e.g., gIOVAs, GVAs) of the page 129 to corresponding GPAs based on one or more sets of guest page tables 275 maintained by the IOMMU driver 120. These guest page tables 275, for example, include data indicating corresponding GPAs for the virtual addresses of the virtual memory space 126 allocated to the VM 112. After translating the virtual addresses of a page 129 to GPAs, hardware IOMMU 108 then provides data to the hypervisor 110 indicating whether the page 129 is to be pinned or unpinned and the GPAs of the page 129.

At block 235, based on the data provided from hardware IOMMU 108 indicating which pages 129 are to be pinned or unpinned, hypervisor 110 pins the GPAs of respective pages 129 to corresponding SPAs within memory 106, unpins the GPAs of respective pages 129 from corresponding SPAs within memory 106, or both. For example, based on data from hardware IOMMU 108 indicating a page 129 is to be pinned, hypervisor 110 first updates or leaves unchanged one or more values (e.g., flags) stored in the page 129 indicating the page is pinned. In implementations, hypervisor 110 then updates one or more host page tables 132 to include data associating the GPAs of the page 129 with corresponding SPAs within memory 106. Additionally, based on data from hardware IOMMU 108 indicating a page 129 is to not be pinned, hypervisor 110 first updates or leaves unchanged one or more values (e.g., flags) stored in the page 129 to indicate the page is unpinned. According to implementations, hypervisor 110 then updates one or more host page tables 132 to disassociate the GPAs of the page 129 from the SPAs within memory 106. After hypervisor 110 has pinned or unpinned each page 129 of the virtual memory space 126 based on the data provided from hardware IOMMU 108, hypervisor 110 then provides, at block 245, a pinning complete notification to hardware IOMMU 108. This pinning complete notification, for example, includes data indicating that each page 129 of the virtual memory space 126 has been pinned or unpinned based on the pinning commands 122.

Based on receiving the pinning complete notification from hypervisor 110, at block 255, hardware IOMMU 108 provides a guest pinning complete notification to the IOMMU driver 120 that includes data indicating that each page 129 of the virtual memory space 126 has been pinned or unpinned based on the pinning commands 122. For example, hardware IOMMU 108 generates one or more guest events indicating that each page 129 of the virtual memory space 126 has been pinned or unpinned based on the pinning commands 122 and stores the guest events in a guest log of VM 112. In response to receiving the guest pinning complete notification from hardware IOMMU 108, at block 265, the IOMMU driver 120 updates one or more guest page tables 275 based on the pinning commands 122. For example, for each pinning command indicating a page 129 is to be pinned, the IOMMU driver 120 updates one or more guest page tables 275 to associate one or more virtual addresses (e.g., gIOVAs, GVAs) with the GPAs of the page 129. Further, for each pinning command indicating a page 129 is not to be pinned, the IOMMU driver 120 updates one or more guest page tables 275 to dissociate one or more virtual addresses (e.g., gIOVAs, GVAs) with the GPAs of the page 129.

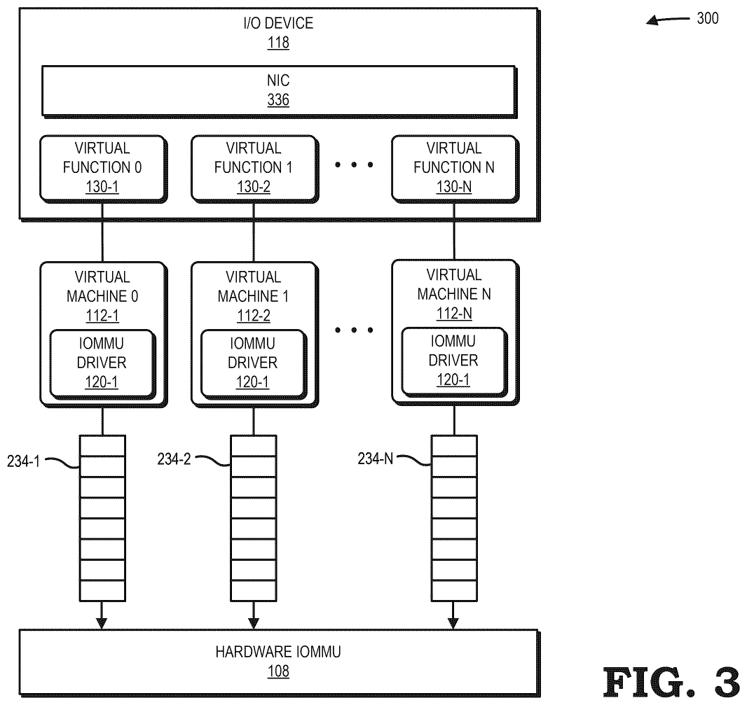

Referring now to FIG. 3, an example system architecture 300 for pinning pages to be used by a VM using a hardware IOMMU is presented, in accordance with some embodiments. In implementations, example system architecture 300 is implemented within processing system 100. Example system architecture 300 includes an I/O device 118, such as an AU 114, network card, sound card, hard disk drive host adapter, RAID controller, modem, or NVMe controller, having a NIC 336 that includes circuitry configured to enable communication between the I/O device 118 and I/O circuit 124 using one or more communication protocols (e.g., USB, PCI, PCIe, ethernet). According to implementations, I/O device 118 implements multiple virtual functions 130 that each represent a respective portion of the I/O device 118 each configured to perform the main function (e.g. physical function) of the I/O device 118. As an example, a virtual function 130 includes a group of resources of the I/O device 118 such as one or more compute units, a portion of memory, registers, and the like together configured to perform the physical function of the I/O device 118. Additionally, in implementations, each virtual function 130 includes a virtual NIC that allows a corresponding VM 112 to control the virtual function 130. In this way, I/O device 118 is configured to expose multiple instances of itself (e.g., virtual functions 130) each configured to perform the main function of I/O device 118. Though the example embodiment presented in FIG. 3 shows I/O device 118 as implementing three virtual functions (130-1, 130-2, 130-N) representing an N integer number of virtual functions (where N>0), in other implementations, I/O device 118 can include any integer number of virtual functions 130.

In implementations, hypervisor 110 is configured to allocate a respective virtual function 130 to a corresponding VM 112 having a IOMMU driver 120 such that the VM 112 is configured to control the virtual function 130. For example, according to the embodiment presented in FIG. 3, hypervisor 110 allocates a first virtual function 0 130-1 to a first virtual machine 0 112-1. For each respective VM 112 controlling a corresponding virtual function 130, hypervisor 110 is configured to pin pages 129 within the virtual memory space 126 allocated to the VM 112 based on which pages 129 will be used by the VM 112. To this end, example system architecture 300 includes a corresponding queue 234 for each virtual function 130 implemented by the I/O device 118. As an example, referring to the embodiment presented in FIG. 3, for the virtual functions 130-1, 130-2, and 130-N implemented by I/O device 118, example system architecture 300 includes a respective queue 234-1, 234-2, 234-N connecting the VM 112 (e.g., processor core 104 executing the VM 112) controlling the corresponding virtual function 130 to hardware IOMMU 108. Each of these queues 234, for example, is included in otherwise connected to hardware IOMMU 108, I/O circuit 124, or both and is configured to store corresponding pinning commands (122-1, 122-2, 122-N) generated by a respective IOMMU driver 120 of a VM 112 controlling a virtual function 130 (e.g., generated by the corresponding VM 112). As an example, based on a first VM 0 112-1 controlling a first virtual function 0 130-1, a corresponding queue 234-1 is configured to store pinning commands 122 generated by the IOMMU driver 120-1 of the first VM 0 112-1. After a respective IOMMU driver 120 of a VM 112 has loaded one or more pinning commands 122 into a queue 234, hardware IOMMU 108 is configured to retrieve the pinning commands 122 and determine which pages 129 of the virtual memory space 126 allocated to the VM 112 to pin, unpin, or both. Based on these determinations, hardware IOMMU 108 then provides data to hypervisor 110 indicating the GPAs of pages 129 to pin to corresponding SPAs within memory 106, the GPAs of pages 129 to unpin, or both. Hypervisor 110 then pins or unpins the pages 129 based on the data provided by the hardware IOMMU 108. In implementations, after hypervisor 110 pins or unpins the pages 129 of a virtual memory space 126 allocated to a VM 112 based on the data provided by the hardware IOMMU 108, the IOMMU driver 120 of the VM 112 is configured to modify a respective set of guest page tables 275 to associate the virtual address of pinned pages 129 to corresponding GPAs.

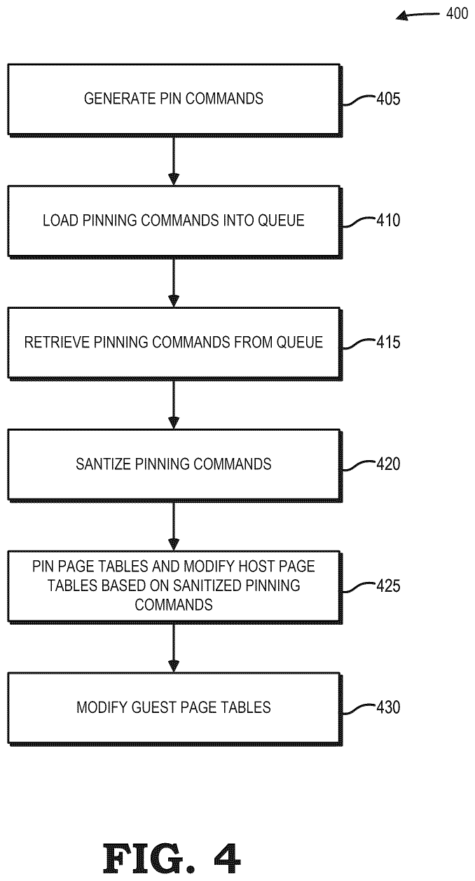

Referring now to FIG. 4, an example method 400 for virtual memory overprovisioning using a hardware IOMMU is presented, in accordance with embodiments. In embodiments, at least a portion of example method 400 is implemented by host processing unit 102 and hardware IOMMU 108. Example method 400 includes, at block 405, hypervisor 110 allocating a virtual memory space 126 having one or more pages 129 to a VM 112 configured to control an I/O device 118 or a virtual function 130 of an I/O device 118. As an example, hypervisor 110 allocates a virtual memory space 126 having a size (e.g., VA range 128) based on one or more predetermined values indicated by the VM 112, the performance of the VM 112, a historical performance of the VM 112, or any combination thereof. Still referring to block 405, for each page 129 of the virtual memory space 126, the IOMMU driver 120 of the VM 112 is configured to generate a corresponding pinning command 122 that includes data indicating a virtual address (e.g., gIOVA, GVA) of the page 129 and whether the page 129 is to be pinned or unpinned. For example, based on the program code of the applications to be executed by the VM 112, the IOMMU driver 120 determines which pages 129 the virtual memory space 126 are going to store data for the applications. Based on determining that a page is going to store data for an application, the IOMMU driver 120 generates a pinning command 122 indicating that the page 129 is to be pinned. Further, based on determining that a page 129 is not going to store data, the IOMMU driver 120 generates a pinning command 122 indicating that the page 129 is not to be pinned. For each pinning command 122 generated, at block 410, the IOMMU driver 120 is configured to load (e.g., enqueue) the pinning command 122 in queue 234 connecting the VM 112 to hardware IOMMU 108. In some implementations, at least a portion of block 405 is performed concurrently with block 410 such that the IOMMU driver 120 loads pinning commands 122 into the queue 234 while concurrently generating other pinning commands 122.

After the IOMMU driver 120 has loaded one or more pinning commands 122 into the queue 234, at block 415, hardware IOMMU 108 is configured to retrieve (e.g., dequeue) the pinning commands 122 from the queue 234. In implementations, hardware IOMMU 108 continues retrieving pinning commands 122 from the queue 234 until a respective pinning command 122 has been retrieved for each page 129 in the virtual memory space 126 allocated to the VM 112. At block 420, hardware IOMMU 108 is configured to sanitize the pinning commands 122 to be performed by hypervisor 110. That is, based on the retrieved pinning commands 122, hardware IOMMU 108 is configured to determine which pages 129 within the allocated virtual memory space 126 to pin to SPA addresses in memory 106, which pages 129 within the allocated virtual memory space 126 to unpin, or both. For example, based on a pinning command 122 indicating a page 129 is to be pinned, hardware IOMMU 108 generates data indicating a virtual address (e.g., GPA) of the page 129 and that the page 129 is to be pinned. Hardware IOMMU 108 then provides this data to hypervisor 110 by, for example, storing the data in a buffer connected to the hardware IOMMU 108 and hypervisor 110. As another example, based on a pinning command 122 indicating a page 129 is not to be pinned, hardware IOMMU 108 generates data indicating a virtual address (e.g., GPA) of the page 129 and that the page 129 is to be unpinned. Hardware IOMMU 108 then provides this data to hypervisor 110 by storing the data in a buffer connected to the hardware IOMMU 108 and hypervisor 110. According to some implementations, hardware IOMMU 108 is configured to translate the virtual addresses of a page 129 (e.g., gIOVA, GVA) to GPAs before provided data indicating the virtual address of the page 129 and whether the page is to be pinned or unpinned to hypervisor 110. As an example, hardware IOMMU 108 first translates a virtual address of a page 129 based on one or more guest page tables 275 maintained by the IOMMU driver 120 and then provides data indicating the GPA of the page 129 and whether the page 129 is to be pinned or unpinned to hypervisor 110.

After hardware IOMMU 108 provides data indicating the virtual address of each page 129 of the allocated virtual memory space 126 and whether the page 129 should be pinned or unpinned, at block 425, hypervisor 110 is configured to pin or unpin the pages 129 of the virtual memory space 126 based on the provided data. For example, based on the provided data indicating that a page 129 is to be pinned, hypervisor 110 updates one or more values stored in the page 129 to indicate that the page 129 is pinned or leaves one or more values stored in the page 129 indicating that the page 129 is pinned unchanged. In implementations, hypervisor 110 then modifies one or more host page tables 132 such that the host page tables 132 include data associating the GPAs of the page 129 with corresponding SPAs in the memory 106. As another example, based on the provided data indicating that a page 129 is not to be pinned, hypervisor 110 updates one or more values stored in the page 129 to indicate that the page 129 is unpinned or leaves one or more values stored in the page 129 indicating that the page 129 is unpinned unchanged. According to implementations, hypervisor 110 then modifies one or more host page tables 132 such that the host page tables 132 do not associate the GPAs of the page 129 with SPAs in the memory 106.

After hypervisor 110 has pinned or unpinned each page 129 of the allocated virtual memory space 126 based on the data provided by hardware IOMMU 108, at block 430, hypervisor 110 provides data to hardware IOMMU 108 that pinning of the allocated virtual memory space 126 is complete. Hardware IOMMU 108 then, in turn, provides data to the VM 112 indicating that pinning of the virtual memory space 126 is completed. For example, hardware IOMMU 108 generates one or more guest events indicating that the pages 129 of the allocated virtual memory space 126 have been pinned based on the pinning commands 122 and stores these guest events in a guest log of VM 112. Still referring to block 430, after receiving the notification from hardware IOMMU 108 that the pinning of the allocated virtual memory space 126 is complete, the VM 112 modifies one or more guest page tables 275 based on the pinning commands 122 generated by the IOMMU driver 120 of the VM 112. For example, the IOMMU driver 120 of the VM 112 updates the guest page tables 275 so as to associate the GPAs of the pages 129 indicated to be pinned by the pinning commands 122 with respective virtual addresses (e.g., gIOVAs, GVAs) of the VM 112. Further, in implementations, the IOMMU driver 120 updates the guest page tables 275 such that the GPAs of the pages 129 indicated to be pinned by the pinning commands 122 are not associated with virtual addresses of the VM 112.

In some embodiments, the apparatus and techniques described above are implemented in a system including one or more integrated circuit (IC) devices (also referred to as integrated circuit packages or microchips), such as the processing system 100 described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system, comprising:
a processing unit configured to:
execute a hypervisor configured to allocate a plurality of pages to a virtual machine (VM) running on the processing unit, wherein the VM includes an input/output memory management unit (IOMMU) driver; and
a hardware IOMMU configured to:
provide data indicating one or more respective pages of the plurality of pages are to be pinned to the hypervisor based on pinning commands received from the IOMMU driver,
wherein the hypervisor is configured to pin the one or more respective pages of the plurality of pages based on the data provided by the hardware IOMMU.

2. The processing system of claim 1, further comprising:
a chiplet implementing the hardware IOMMU.

3. The processing system of claim 1, wherein:
the IOMMU driver is configured to maintain a set of guest page tables; and
the hardware IOMMU is configured to translate virtual addresses of the plurality of pages based on the set of guest page tables.

4. The processing system of claim 1, wherein hardware IOMMU is configured to:
notify the VM that pinning is completed by updating a guest log.

5. The processing system of claim 1, wherein the hypervisor is configured to:
modify a set of host page tables based on the pinning commands.

6. The processing system of claim 1, further comprising:
a queue accessible by the processing unit and the hardware IOMMU, wherein the queue is configured to store the pinning commands from the IOMMU driver.

7. The processing system of claim 1, wherein the hardware IOMMU is configured to:
store the data indicating the one or more respective pages of the plurality of pages are to be pinned in a circular buffer accessible by the hypervisor.

8. A method, comprising:
executing, by a processing unit, a hypervisor configured to allocate a plurality of pages to a virtual machine (VM) running on the processing unit, wherein the VM includes an input/output memory management unit (IOMMU) driver;
based on pinning commands received from the IOMMU driver, providing, by a hardware IOMMU, data to the hypervisor indicating one or more respective pages of the plurality of pages are to be pinned; and
pinning, by the hypervisor, the respective one or more pages of the plurality of pages based on the data provided by the hardware IOMMU.

9. The method of claim 8, further comprising:
maintaining, by the IOMMU driver, a set of guest page tables; and
translating, by the hardware IOMMU, virtual addresses of the plurality of pages based on the set of guest page tables.

10. The method of claim 9, further comprising:
notifying, by the hardware IOMMU, the VM that pinning is completed by updating a guest log.

11. The method of claim 8, further comprising:
modifying a set of host page tables maintained by the hypervisor based on the pinning commands.

12. The method of claim 8, further comprising:
storing, in a queue connected to the processing unit and the hardware IOMMU, pinning commands from the IOMMU driver.

13. The method of claim 8, further comprising:
storing the data indicating the one or more respective pages of the plurality of pages are to be pinned in a circular buffer accessible by the hypervisor.

14. A processing system, comprising:
a processing unit configured to execute a hypervisor and a plurality of virtual machines (VMs);
an input/output (I/O) device configured to implement a plurality of virtual functions, wherein each virtual function of the plurality of virtual functions is allocated to a respective VM of the plurality of VMs; and
a plurality of queues, wherein each queue of the plurality of queues is accessible by a corresponding VM of the plurality of VMs and a hardware input/output memory management unit (IOMMU) and is configured to store pinning commands generated by the corresponding VM.

15. The processing system of claim 14, wherein the hypervisor is configured to:
for each VM of the plurality of VMs:
allocate a respective plurality of pages; and
pin one or more pages of the respective plurality of pages based on pinning commands stored in a corresponding queue of the plurality of queues connected to the VM.

16. The processing system of claim 15, wherein the hardware IOMMU is configured to:
for each VM of the plurality of VMs:
translate virtual address of the respective plurality of pages based on a respective set of guest page tables maintained by the VM.

17. The processing system of claim 16, wherein each VM of the plurality of VMs is configured to:
modify the respective set of guest page tables based on the pinning commands stored in the corresponding queue of the plurality of queues connected to the VM.

18. The processing system of claim 14, wherein the hypervisor is configured to:
modify a set of host page tables based on the pinning commands stored in one or more queues of the plurality of queues.

19. The processing system of claim 14, wherein the hardware IOMMU is implemented as a chiplet.

20. The processing system of claim 14 wherein the I/O device includes an acceleration unit (AU).
